(19) United States
(12) Patent Application Publication
(10) Pub. No.: US 2026/0227636 A1
(43) Pub. Date: Aug. 6, 2026

(54) VARIABLE SPEED ACTUATORS

(71) Applicant: Meta Platforms Technologies, LLC, Menlo Park, CA (US)

(72) Inventors: Kenneth Alexander Diest, Kirkland, WA (US); Shaomin Xiong, Newark, CA (US); Lidu Huang, Danville, CA (US)

(21) Appl. No.: 19/453,403

(22) Filed: Jan. 20, 2026

Related U.S. Application Data
(60) Provisional application No. 63/752,456, filed on Jan. 31, 2025.

(51) Int. Cl. G02B 27/01; F03G 7/06; G02B 7/02

(52) U.S. Cl. CPC G02B 27/0179; F03G 7/06143; G02B 7/028; G02B 27/0176

(57) ABSTRACT

A lens assembly includes a display, a lens, an actuation block, and processing logic. The display is configured to generate display light including an image. The lens is configured to focus the display light. The actuation block is configured to adjust a spacing between the lens and the display. The actuation block includes a shape memory alloy (SMA) actuator. The processing logic is configured to operate the SMA actuator to control an actuation speed of the SMA actuator.

### CROSS-REFERENCE TO RELATED APPLICATIONS

This application claims priority to U.S. provisional Application No. 63/752,456 filed January 31, 2025, which is hereby incorporated by reference.

### TECHNICAL FIELD

This disclosure relates generally to optics, and in particular to variable speed actuators.

### BACKGROUND INFORMATION

Shape Memory Alloy (SMA) actuators have gained significant attention in recent years due to their unique ability to undergo a reversible phase transformation, allowing them to change shape or generate force. These actuators have been increasingly used in various industries, including aerospace, automotive, and biomedical devices, due to their power-to-weight ratio, compact size, low power consumption, among other attributes. Typically, SMA actuators “remember” two distinct shapes. The SMA transformation from a first phase to a second phase, resulting in a rapid change in shape, is often referred to as actuation. This phase transformation enables SMA actuators to quickly switch between two actuation positions, making them attractive for applications requiring rapid control.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a shape memory alloy (SMA) actuator system in a contracted state to facilitate a short focal plane, in accordance with aspects of the disclosure.

FIG. 2 illustrates an SMA actuator system in an expanded state to facilitate a far focal plane, in accordance with aspects of the disclosure.

FIG. 3 illustrates a top view of the SMA actuator system in the contracted state of FIG. 1, in accordance with aspects of the disclosure.

FIG. 4 illustrates a top view of the SMA actuator system in the expanded state of FIG. 2, in accordance with aspects of the disclosure.

FIG. 5A illustrates an attenuator circuit coupled between processing logic and an actuation block, in accordance with aspects of the disclosure.

FIG. 5B illustrates a low pass (LP) filter coupled between processing logic and an actuation block, in accordance with aspects of the disclosure.

FIGS. 6A-6D illustrate SMA wires having various physical properties and characteristics, in accordance with aspects of the disclosure.

FIG. 7A illustrates a conventional electrical current profile to drive an SMA actuator from an expanded state to a contracted state.

FIG. 7B illustrates a progressive electrical current profile to drive an SMA actuator from an expanded state to a contracted state, in accordance with aspects of the disclosure.

FIG. 7C illustrates the traditional trajectory motion of an SMA actuator driven with the traditional current profile of FIG. 7A.

FIG. 7D illustrates a progressive trajectory motion of an SMA actuator driven with the progressive current profile of FIG. 7B, in accordance with aspects of the disclosure.

FIG. 8A illustrates a cross-section of an example SMA actuator, in accordance with aspects of the disclosure.

FIG. 8B illustrates an example SMA actuator having a sheath that mechanically restricts contraction of the SMA actuator, in accordance with aspects of the disclosure.

FIG. 9 illustrates an SMA actuator system that includes magnetic elements, in accordance with aspects of the disclosure.

FIGS. 10A-B illustrate an example head-mounted display (HMD) that may include an SMA actuator system, in accordance with aspects of the disclosure.

### DETAILED DESCRIPTION

Embodiments of variable speed actuators are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

In aspects of this disclosure, visible light may be defined as having a wavelength range of approximately 380 nm – 700 nm. Non-visible light may be defined as light having wavelengths that are outside the visible light range, such as ultraviolet light and infrared light. Infrared light having a wavelength range of approximately 700 nm – 1 mm includes near-infrared light. In aspects of this disclosure, near-infrared light may be defined as having a wavelength range of approximately 700 nm - 1.6 µm.

In aspects of this disclosure, the term “transparent” may be defined as having greater than 90% transmission of light. In some aspects, the term “transparent” may be defined as a material having greater than 90% transmission of visible light.

Shape memory alloys are materials that can be deformed (e.g., stretched) from an initial shape, and then manipulated in some way that causes a phase change in the material, which in turn causes the material to change back to an initial shape. The phase change can be produced through various techniques depending on the type of SMA, though most commonly thermal SMAs are utilized, which have a crystalline phase that depends on temperature. A thermal SMA can be deformed when the material is below a critical temperature, but when the material is heated to above this critical temperature, the material will change back to its initial shape. Thermal SMAs can be utilized as actuators by coupling an SMA to a payload, and by heating the SMA to produce actuation from a deformed shape back to an initial shape, thereby moving the payload. SMAs operated in this manner, whether thermal SMAs or otherwise, are referred to herein as SMA actuators. Hereinafter, discussion of SMAs focuses on thermal SMAs, though it will be appreciated that the techniques described herein may also be applicable to other types of SMAs, and are not limited for use with thermal SMAs.

Generally, the utilization of SMA actuators in devices focuses on ways to increase the speed of actuation, which allows the technology to be used in a wider range of applications. In contrast, the present disclosure relates to techniques to control the speed of actuation, and particularly to reduce the speed of actuation of an SMA actuator. For certain applications, examples of which are described herein, the speed of an SMA actuator may be too fast to produce a desired result.

In implementations of the disclosure, SMA actuators can be arranged in pairs (or larger groups) that are coupled to the same payload. In this configuration, the SMA actuators are arranged so that when one of the SMA actuators is deformed, the other SMA actuator is in an initial shape (or at least a substantially un-deformed shape), and vice versa. For example, when a first SMA actuator is heated to above its critical temperature, the second SMA actuator remains below this temperature and so the first SMA actuator changes back to its initial shape, thereby moving the payload and deforming the second SMA actuator. This process can be repeated by heating the second SMA actuator while the first SMA actuator remains below the critical temperature to move the payload in the opposite direction. In this manner, the payload can be moved between two positions by heating, and thereby actuating, the appropriate SMA actuator of the pair.

In an example of the disclosure, artificial reality (AR) eyewear devices or mixed reality (MR) or virtual reality (VR) headsets may enable users to experience events, such as interactions with people in a computer-generated simulation of a three-dimensional world, or to view data superimposed on a real-world view. Stereoscopic images may be exhibited on an electronic display inside an HMD to simulate motion and the illusion of depth for information being viewed by a user. Disclosed herein is an adaptive focus display having an SMA actuator that is adapted to mechanically and controllably adjust the distance between a display element and a lens system, and to accordingly tune the location of a virtual image in an associated display. Techniques are described herein for operating such a system in which the speed of actuation of the SMA actuator, and therefore the speed at which a display element and/or lens system is moved, is controlled. In some cases, an SMA actuator in an artificial reality system may, when operated, cause the distance between the display element and lens system to adjust too quickly enough that it causes undesirable viewing effects for a user of the display. For instance, in an HMD, the location of a virtual image may change rapidly. The techniques described herein allow the speed of actuation of an SMA actuator to be controlled, and in particular to be slowed, such that the undesirable viewing effects may be avoided.

According to some embodiments, an SMA actuator may be controlled electrically, so that an electrical signal causes the SMA actuator to be heated. For instance, an electrical signal could comprise a current that passes through the SMA actuator and/or a nearby material, thereby heating the actuator through resistive heating. Controlling the speed of actuation of the SMA actuator may comprise modulating the electrical signal in some manner that inhibits the electrical signal from fully causing actuation of the actuator. For instance, a current directed through an SMA actuator may be arranged to be below (e.g., slightly below) a critical value for actuation, where the critical current value corresponds to a critical temperature of the SMA to cause a phase transformation. Additionally, or alternatively, a current directed through an SMA actuator may be modulated through pulse width modulation, pulse amplitude modulation and/or pulse density modulation, wherein none, some, or all of the current pulses directed through the SMA actuator are (partially or wholly) below the critical current needed to cause actuation. In some embodiments, a system may comprise an attenuator circuit that attenuates the current directed through an SMA actuator (e.g., between a control circuit and the actuator). Such an attenuator may be active or passive. In some embodiments, a system may comprise a low pass filter that can be tuned (e.g., through tuning of an integration filter) to adjust a current directed through an SMA actuator.

According to some embodiments, an SMA actuator may be coupled to one or more mechanical components that in some way inhibit its motion during actuation. For instance, a damper (e.g., a fixed friction or variable friction brake) may be coupled to the SMA actuator to limit its actuation speed. Additionally, or alternatively, one or more actuators (SMA actuators or otherwise) may be driven anti-parallel to an SMA actuator, and operated to produce a force that is less than that of the SMA actuator, thereby slowing the SMA actuator. Additionally, or alternatively, an SMA actuator may be coupled to a payload via a connection point that can be operated to change the angle of actuation and thereby change the resultant speed of actuation.

According to some embodiments, the speed of an SMA actuator during actuation may be controlled magnetically. For instance, a magnetic field may be applied to the SMA actuator that interacts with the structure (e.g., chemistry) of the SMA material to change its response to being heated. Additionally, or alternatively, a magnetic field may be applied to a magnetic element within the SMA actuator that adjusts a manner in which the SMA actuator moves when actuated.

According to some embodiments, the speed of an SMA actuator during actuation may be controlled electrostatically.

According to some embodiments, the speed of an SMA actuator during actuation may be controlled thermally. For instance, an ambient temperature around the SMA actuator may be controlled to impact the actuation speed of the SMA actuator.

According to some embodiments, multiple SMA actuators may be combined to form a single combined SMA actuator, wherein the multiple SMA actuators have different physical properties such that the speed of the combined SMA actuator can be controlled by selecting a desired one of the multiple SMA actuators and actuating it. The different physical properties may include different dimensions (e.g., lengths, cross-sectional areas, etc.) and/or may include different material compositions of the SMA.

According to some embodiments, a system may comprise one or more sheaths around an SMA actuator that impede the SMA actuator from moving. For instance, a sheath may mechanically restrict the SMA actuator’s ability to contract. Additionally, or alternatively, a sheath may comprise a material with a high thermal conductivity that acts as a heat sink which impedes the SMA actuator from reaching its critical temperature.

According to some embodiments, an SMA actuator may be operated in a plurality of steps to increase the time between the start and end of the actuation process. For instance, whereas a current profile that rapidly jumps to a desired current may produce quick actuation of an SMA actuator, it may be desirable to gradually step up the current to the desired current and thereby cause slower actuation. For instance, the current may be increased a step, followed by a delay time, following by another step increase, followed by another delay time, etc.

Any of the above techniques for controlling the speed of actuation of an SMA actuator may be applied together in any suitable combination.

An SMA actuator may be configured for direct or indirect tuning (e.g., via SMA wires attached to a display element or operative through an intermediate structure, such as a gasket or sleeve). An SMA actuator may provide an actuation force to a gasket, for example, that provides a restoring force when the actuator is disengaged. In some embodiments, a locking mechanism may be configured to secure a display element and inhibit unwanted displacement between actuation events.

Various SMA actuator systems are contemplated, including direct and indirect configurations. SMA wires may be attached directly to a display element, for example, or to an intervening linkage. In this implementation, the display element may be moved by the SMA actuator while an optics block including a lens remains stationary. SMA wires may be attached directly to an optics block that includes a lens, for example, or to an intervening linkage. In this implementation, the optics block may be moved by the SMA actuator while the display element remains stationary. In certain embodiments, a system may include one or more SMA driving wires and one or more complementary SMA restoring wires that are configured to be alternately actuated to “push” and “pull” an associated display element.

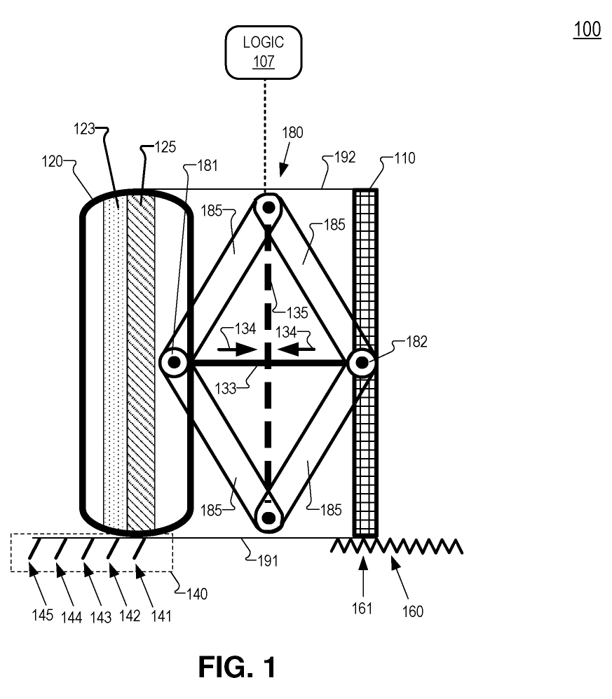

Features from any of the embodiments described herein may be used in combination with one another in accordance with the general principles described herein. These and other embodiments, features, and advantages will be more fully understood upon reading the following detailed description in conjunction with the accompanying drawings and claims. These and other embodiments are described in more detail in connection with FIGS. 1-10B.

FIG. 1 illustrates a shape memory alloy (SMA) actuator system 100 in a contracted state to facilitate a short focal plane, in accordance with aspects of the disclosure. SMA actuator system 100 includes a display 110, an optics block 120, an actuation block 180, and processing logic 107. SMA actuator system 100 may be configured to control the actuation speed of one or more SMAs included in system 100. In some implementations, processing logic 107 is configured to reduce the actuation speed of one or more SMAs compared to a default actuation speed of SMAs within system 100.

SMA actuator system 100 may be used as a lens assembly and the lens assembly may be used in head-mounted devices, in aspects of the disclosure. Display 110 may include a two-dimensional array of display pixels that generate display light. Display 110 may include a liquid crystal display (LCD), an organic light emitting diode (OLED) display, or a micro-LED display, for example. An image may be driven onto the display 110. In the context of head-mounted device, a virtual image may be driven onto the display 110 and display 110 may be considered a near-eye display.

Optics block 120 may be a lens that includes one or more layers such as lens layer 123 and/or lens layer 125. The lens layers may include polarizers, reflective polarizers, wavelength filters, partial mirrors, or other optical layers. Optics block 120 may include a “pancake lens” design. Optics block 120 may include one or more refractive lens surfaces. Optics block 120 may include one or more diffractive optical elements. Optics block 120 may include metasurfaces. Optics block 120 may be configured to focus the display light from display 110. In the context of head-mounted device, optics block 120 may be configured to focus a virtual image to an eyebox region.

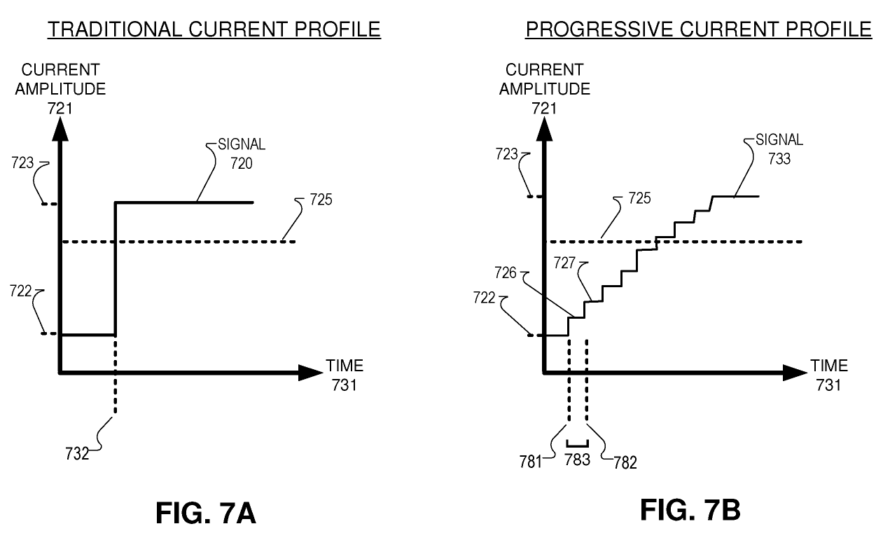

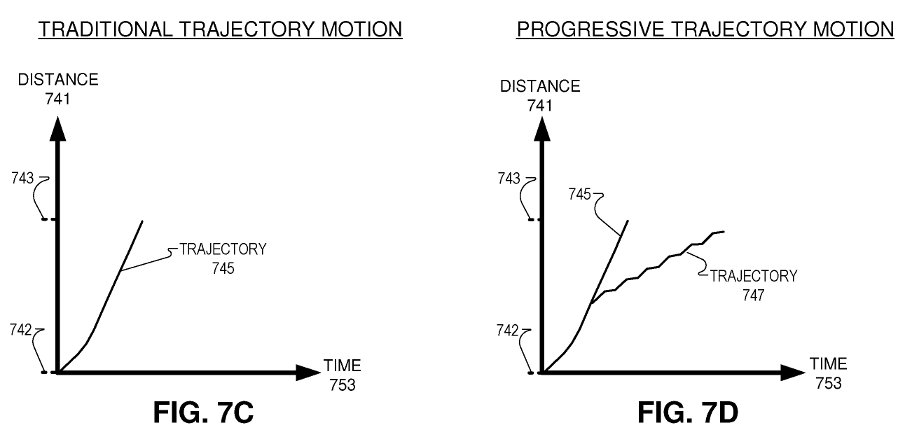

In operation, processing logic 107 is configured to operate one or more SMA actuators included in actuation block 180 to adjust a spacing between optics block 120 and display 110. This adjustment of spacing may assist in focusing a virtual image to an eyebox region. In the illustration of FIG. 1, actuation block 180 include a first SMA actuator 133 and a second SMA actuator 135. The example of FIG. 1 shows first SMA actuator 133 disposed in a horizontal orientation while second SMA actuator 135 is disposed in a vertical orientation that may be approximately orthogonal to first SMA actuator 133. In FIG. 1, SMA actuator 133 is contracted while SMA actuator 135 is relaxed (expanded) and the spacing between display 110 and optics block 120 is reduced. The contracted SMA actuator 133 is illustrated with a solid line and the relaxed SMA actuator 135 is illustrated with a dash line. Processing logic 107 may drive SMA actuator 133 and SMA actuator 135 to their different contracted and relaxed states. For example, in FIG. 1, processing logic 107 is driving SMA actuator 133 to a contracted state that provides pulling force 134 to pulls pivot points 181 and 182 together that reduces the spacing between display 110 and optics block 120. In implementations of the disclosure that will be described in more detail in association with the descriptions of FIGS. 7A-7D, processing logic 107 will drive SMA actuator 133 and SMA actuator 135 to different states using novel driving techniques with regard to drive current and/or timing.

In FIG. 1, actuation block 180 includes linkages 185 that are mechanically coupled to pivot points 181 and 182. Linkages 185 may be included in a V-linkage system. Other linkage systems may be used. Linkages 185 may be considered pivotably disposed linkage arms. In the example illustration of FIG. 1, SMA actuators 133 and 135 are configured to apply a stress (e.g., to a flexure or linkage element) that induces a net displacement of an image plane of display 110 with respect to optics block 120. In certain configurations, the SMA actuators 133 and 135 may be arranged to move both display 110 and the optics block 120. The SMA actuators 133 and 135 may also be arranged to move the display 110 to the exclusion of the optics block 120 or to move the optics block 120 to the exclusion of the display 110.

In some implementations, a scissor linkage system is utilized in actuation block 180 where multiple pairs of crossed arms are connected at pivot points 181 and 182 forming a diamond-shaped structure that can expand and contract. When the linkage system is in a collapsed state, SMA actuator 133 is contracted while SMA actuator 135 is relaxed (and expanded) forcing linkages 185 to fold closer together and reduce spacing between optics block 120 and display 110. When the linkage system is in an expanded state, SMA actuator 133 is relaxed (and expanded) while SMA actuator 135 is contracted forcing linkages 185 to open farther apart and increase spacing between optics block 120 and display 110. In implementations of the disclosure, guide rails 191 and 192 may be included in SMA actuator system 100 to provide alignment support for optics block 120 and/or display 110 as optics block 120 is moved with respect to display 110 or display 110 is moved with respect to optics block 120.

There may be multiple mechanical positions of actuation block 180 in between fully expanded and fully collapsed in order to provide multiple spacing distances between display 110 and optics block 120. The multiple spacing distances may correspond to multiple focusing distances for virtual images driven onto display 110.

If display 110 is in a fixed position and optics block 120 is moving with respect to the fixed position of display 110, mechanical stop module 140 may provide different mechanical stops for optics block 120 to move to with respect to display 110. In other words, various actuation controls of SMA actuators 133 and 135 may correspond with mechanical stops 141, 142, 143, 144, and 145 in order to provide granularity in controlling SMA actuators 133 and 135 rather than the conventional approach of having just two positions (fully contracted and fully expanded) for actuation block 180. Mechanical stops 141, 142, 143, 144, and 145 may be implemented as indents in a material that encourage optics block 120 to reside in a particular position corresponding to different focal planes of SMA actuator system 100. Processing logic 107 may drive SMA actuators 133 and 135 to the different positions of mechanical stops 141, 142, 143, 144, and 145.

FIG. 1 illustrates an optional friction pad 160 configured to provide stopping points for the display 110 for implementations where display 110 is configured to move with respect to optics block 120. In some implementations, display 110 is slidably engaged with a track system that includes guide rails 191 and 192. Friction pad 160 may be a fixed-friction or variable-friction brake acting as a damping element to reduce the actuation speed of SMA actuators in actuation block 180. Friction pad 106 is configured to reduce the actuation speed of actuation block 180 from the default actuation speed of SMA actuators 133 or 135. Friction pad 106 may reduce the speed of actuation block 180 in both the expanded and contracted directions. In FIG. 1, actuation block 180 is in a contracted state and display 110 is at position 161 of friction pad 160.

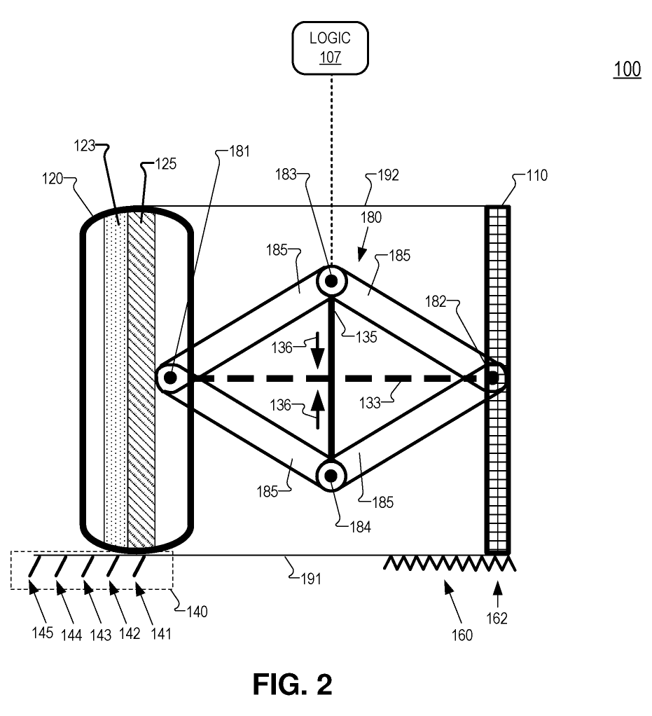

FIG. 2 illustrates SMA actuator system 100 in an expanded state to facilitate a far focal plane, in accordance with aspects of the disclosure. In FIG. 2, SMA actuator 133 is relaxed (expanded) while SMA actuator 135 is contracted and the spacing between display 110 and optics block 120 is increased compared to the contracted state of FIG. 1. The contracted SMA actuator 135 is illustrated with a solid line and the relaxed SMA actuator 133 is illustrated with a dash line. Processing logic 107 may drive SMA actuator 133 and SMA actuator 135 to the contracted and relaxed states shown in FIG. 2. For example, in FIG. 2, processing logic 107 is driving SMA actuator 135 to a contracted state that provides pulling force 136 to pulls pivot points 183 and 184 together that increases the spacing between display 110 and optics block 120.

In FIG. 2, actuation block 180 is in an expanded state and display 110 is at position 162 of friction pad 160. Processing logic 107 may drive SMA actuators 133 and 135 to switch states from their actuation states illustrated in FIG. 1. Accordingly, display 110 may have changed positions from position 161 on friction pad 160 to position 162 on friction pad 160. Yet, the friction of friction pad 160 may slow the motion of display 110 from position 161 to 162 so that the motion is dampened from the motion that would result without friction pad 160. This dampening may smooth the transition of the focal plane of a virtual image for a user viewing a virtual image driven onto display 110.

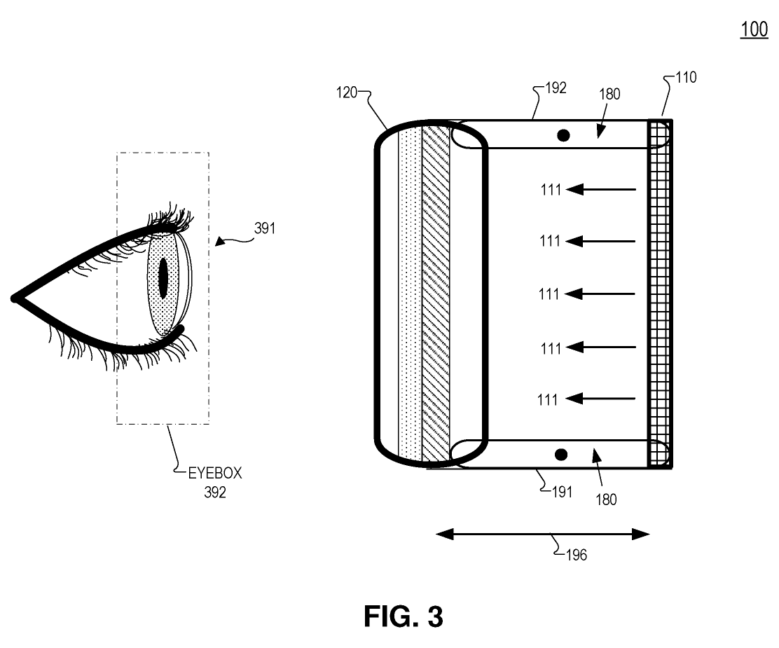

FIGS. 1 and 2 may illustrate a side view of SMA actuator system 100. FIG. 3 illustrates a top view of SMA actuator system 100 in the contracted state of FIG. 1, in accordance with aspects of the disclosure. FIG. 3 illustrates display 110 generating display light 111 emitted toward optics block 120. Optics block 120 focuses display light 111 to the eye 391 of a user in an eyebox region 392 of a head-mounted device. FIG. 3 illustrates that the contracted state of SMA actuator system 100 corresponds to a first object distance 196 between the optics block 120 and the display 110.

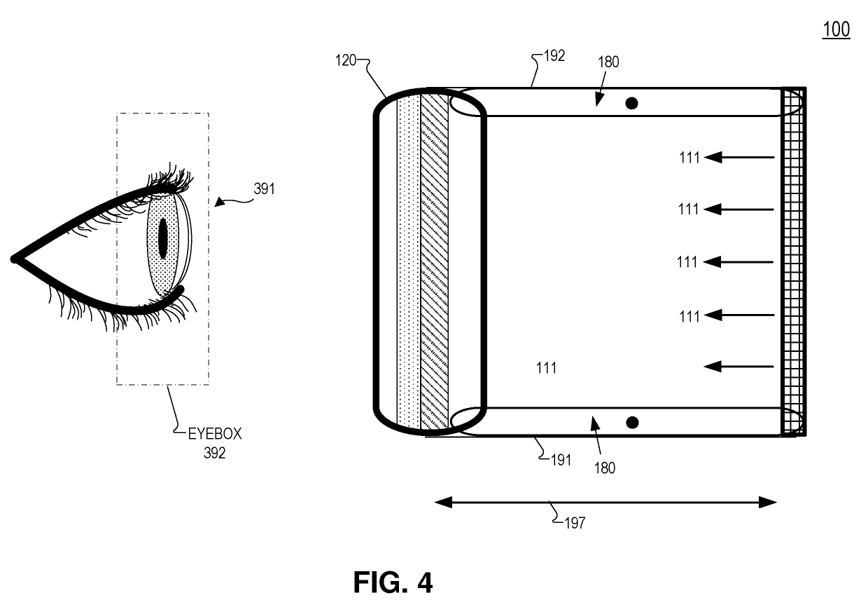

FIG. 4 illustrates a top view of SMA actuator system 100 in the expanded state of FIG. 2, in accordance with aspects of the disclosure. FIG. 4 illustrates display 110 generating display light 111 emitted toward optics block 120. Optics block 120 focuses display light 111 to the eye 391 of a user in an eyebox region 392 of a head-mounted device. FIG. 4 illustrates the expanded state of SMA actuator system 100 corresponds to a second object distance 197 between the optics block 120 and the display 110.

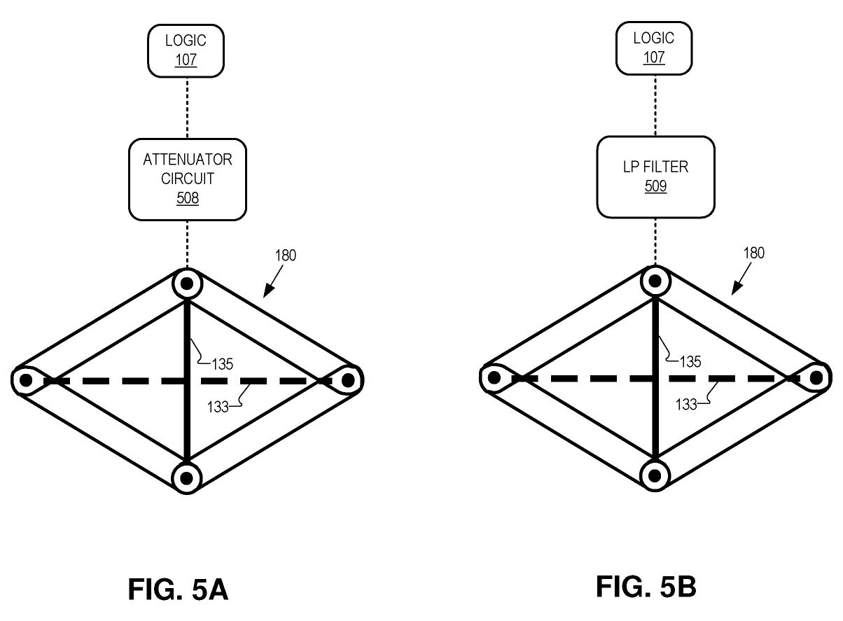

FIG. 5A illustrates an attenuator circuit 508 coupled between processing logic 107 and actuation block 180, in accordance with aspects of the disclosure. Attenuator circuit 508 is coupled to processing logic 107 and to at least one of the SMA actuators 133 and/or 135. Processing logic 107 is configured to control the actuation speed of the SMA actuator(s) by directing a signal to the SMA actuator via the attenuator circuit 508. In an implementation, attenuator circuit 508 is configured to reduce the power or amplitude of the signal received from processing logic 107 without significantly distorting its waveform. In some implementations, attenuator circuit 508 includes passive electrical elements to provide a specific amount of loss.

FIG. 5B illustrates a low pass (LP) filter 509 coupled between processing logic 107 and actuation block 180, in accordance with aspects of the disclosure. LP filter 509 is coupled to processing logic 107 and to at least one of the SMA actuators 133 and/or 135. Processing logic 107 is configured to control the actuation speed of the SMA actuator(s) by directing a signal to the SMA actuator via the LP filter 509. In an implementation, LP filter 509 includes one or more resistors and capacitors to form a low pass filter.

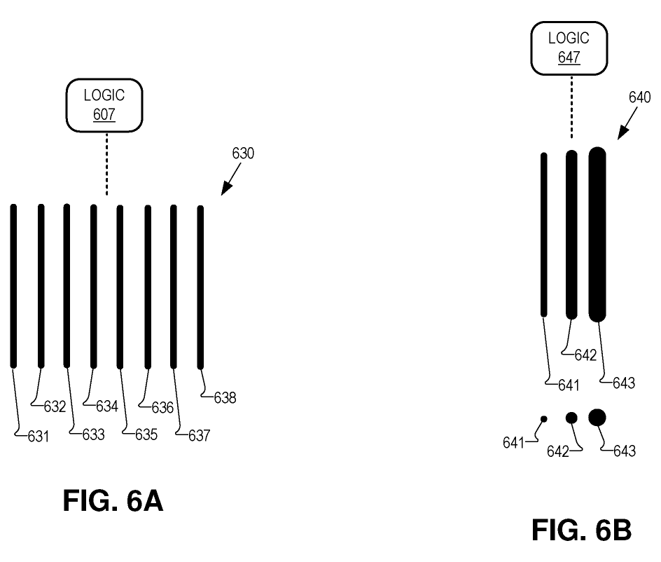

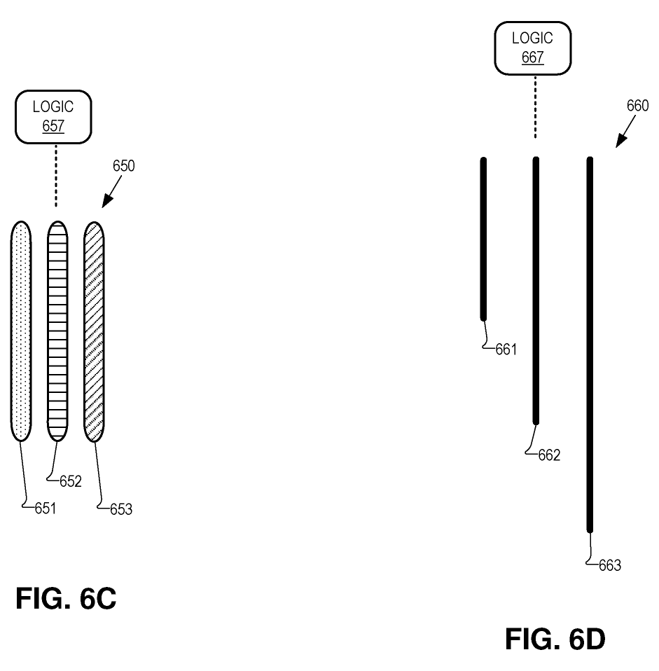

FIGS. 6A-6D illustrate a plurality of SMA wires that may be used in SMA actuators of the disclosure. Multiple SMA wires may be present in each SMA actuator. In some implementations, each SMA wire has distinct physical properties and one or more individual SMA wires are selected for which result in varying actuation speeds and a subset of the wires are actuated depending on a required actuation speed.

FIG. 6A illustrates a plurality of SMA wires 630 having similar physical properties, in accordance with aspects of the disclosure. The plurality of SMA wires 630 includes eight SMA wires 631, 632, 633, 634, 635, 636, 637, and 638. However, the plurality of SMA wires may include any integer number of SMA wires. The SMA wires 630 may have similar length, cross-section, and physical composition as one another. In implementations, the disclosed SMA actuator may include a plurality of SMA wires having similar physical properties and processing logic 607 is configured to control the actuation speed of the SMA actuator by actuating a subset of the plurality of SMA wires 630. Actuating a subset of the SMA wires 630 may reduce the actuation speed of an SMA actuator compared to actuating all of the SMA wires at the same time. In some implementations, SMA wire 631 is actuated, followed by SMA wire 632, followed by SMA wire 633, and so on, until each SMA wire is successively actuated.

FIG. 6B illustrates SMA wires 640 having different cross-sections, in accordance with aspects of the disclosure. The plurality of SMA wires 640 includes SMA wires 641, 642, and 643. However, the plurality of SMA wires 640 may include any integer number of SMA wires. SMA wire 642 has a larger cross-section than SMA wire 641 and SMA wire 643 has a larger cross-section than SMA wire 642. In implementations, the disclosed SMA actuator may include a plurality of SMA wires having different physical properties such as different cross-sections. Processing logic 647 is configured to control the actuation speed of the SMA actuator by actuating a subset of the plurality of SMA wires 640. Actuating a subset of the SMA wires 640 may reduce the actuation speed of an SMA actuator compared to actuating all of the SMA wires at the same time. In some implementations, SMA wire 641 is actuated, followed by SMA wire 642, followed by SMA wire 643. In other words, the SMA wire with the smallest cross-section may be actuated first and the SMA wires with progressively larger cross-sections are actuated until the SMA wire with the largest cross-section is actuated.

FIG. 6C illustrates SMA wires 650 having different physical composition, in accordance with aspects of the disclosure. The plurality of SMA wires 650 includes SMA wires 651, 652, and 653. However, the plurality of SMA wires 650 may include any integer number of SMA wires. SMA wire 652 has a different physical composition than SMA wire 651 and SMA wire 653 has a different physical composition than SMA wire 652. Different SMA wires may be Nickel-Titanium based, Copper-based alloy (e.g. copper-aluminum-nickel), or iron-based alloy (e.g. iron-manganese-silicon), for example. Processing logic 657 may be configured to control the actuation speed of the SMA actuator by actuating a subset of the plurality of SMA wires 650. Actuating a subset of the SMA wires 650 may reduce the actuation speed of an SMA actuator compared to actuating all of the SMA wires at the same time. In some implementations, the SMA wire in the plurality of SMA wires 650 having the least contraction force is actuated first followed by the SMA wires having increasingly larger contraction forces.

FIG. 6D illustrates SMA wires 660 having different lengths, in accordance with aspects of the disclosure. The plurality of SMA wires 660 includes SMA wires 661, 662, and 663. However, the plurality of SMA wires 660 may include any integer number of SMA wires. SMA wire 662 has a longer length than SMA wire 661 and SMA wire 643 has a longer length than SMA wire 642. In implementations, the disclosed SMA actuator may include a plurality of SMA wires having different physical properties such as different lengths. Processing logic 667 is configured to control the actuation speed of the SMA actuator by actuating a subset of the plurality of SMA wires 660. Actuating a subset of the SMA wires 660 may reduce the actuation speed of an SMA actuator compared to actuating all of the SMA wires at the same time. In some implementations, SMA wire 663 is actuated, followed by SMA wire 662, followed by SMA wire 661.

FIG. 7A illustrates a conventional electrical current profile to drive an SMA actuator from an expanded state to a contracted state. In response to the conventional electrical current profile illustrated in FIG. 7A, the SMA actuator moves at a fast default actuation speed shown by trajectory 745 in FIG. 7C. FIG. 7A shows at time 732, current signal 720 goes from amplitude 722 to amplitude 723 in a step function. A step function current profile results in the default actuation speed that is typical for conventional SMA actuator systems. Current amplitude 723 is above a critical current value 725 for actuating an SMA actuator. Critical current value 725 may correspond to a critical temperature value for actuation an SMA actuator.

FIG. 7B illustrates a progressive electrical current profile to drive an SMA actuator from an expanded state to a contracted state, in accordance with aspects of the disclosure. In response to the progressive electrical current profile illustrated in FIG. 7B, the SMA actuator moves at a reduced actuation speed shown by trajectory 747 in FIG. 7D. FIG. 7B illustrates current signal 733 moving from amplitude 722 to amplitude 723 in a progression. Current signal 733 is an example of a modulated current signal that may be directed to one or more SMA actuators by processing logic 107, in accordance with aspects of the disclosure. In this way, the processing logic is able to control the actuation speed of the SMA actuator by modulating the current signal to a current signal other than the conventional step function of FIG. 7A.

In the example of FIG. 7B, current signal 733 starts at amplitude 722 and modestly increases in current in incremental steps where each current amplitude is held for a time period for each step. For example, the first step starts at time 781 where the current is increased from amplitude 722 to amplitude 726. The current is held at amplitude 726 for a time period 783 and then the current amplitude is increased from amplitude 726 to amplitude 727 at time 782. Current signal 733 continues to climb in modest incremental steps until it reaches (or exceeds) current amplitude 723. Notably, a portion of current signal 733 is below the critical current value 725 for actuation of an SMA actuator while the current signals increases from amplitude 722 to amplitude 723. In some implementations, the current signal spends more time below the critical current value 725 than above the critical current value 725 during the transition from amplitude 722 to amplitude 723.

FIG. 7C illustrates the traditional trajectory motion of an SMA actuator driven with the traditional current profile of FIG. 7A where the SMA actuator begins at distance 742 and moves to distance 743 along trajectory 745 over time.

FIG. 7D illustrates a progressive trajectory motion 747 of an SMA actuator driven with the progressive current profile of FIG. 7B, in accordance with aspects of the disclosure. The SMA actuator begins at distance 742 and approaches distance 743 along trajectory 747 over a longer time period than conventional trajectory 745. In other words, driving an SMA actuator with current signal 733 reduced the actuation speed of an SMA actuator from the default actuation speed illustrated in trajectory 745. Trajectory 747 is overlaid over trajectory 745 for visual comparison in FIG. 7D.

In implementations of the disclosure, the processing logic is configured to control the actuation speed of the SMA actuator by increasing an amplitude of a current signal directed into the SMA actuator in a plurality of steps, as illustrated in FIG. 7B. And, increasing the amplitude of the current signal in a plurality of steps may include a delay time (e.g. time period 783) between each of the plurality of steps.

In some implementations, modulating the current signal provided to the SMA actuator (e.g. by processing logic 107) includes driving the SMA actuator at a continuous current value that is below a critical current value for actuation of the SMA actuator.

In some implementations, modulating the current signal provided to the SMA actuator (e.g. by processing logic 107) includes pulse width modulation. An amplitude of at least a portion of pulses generated by the pulse width modulation may be below a critical current value (e.g. critical current value 725) for actuation of the SMA actuator. In implementations, pulse amplitude modulation and/or pulse density modulation are used to modulate the current signal, wherein none, some, or all of the current pulses directed through the SMA actuator by processing logic are (partially or wholly) below the critical current needed to cause actuation.

In the case of thermally actuated SMA actuators, modulation of the current driving an SMA actuator may correspond to the temperature required to actuate the SMA actuator. Thus a critical current value may correspond to a thermal threshold required for transformation of the SMA actuator between the martensite phase (low-temperature deformable state) and the austenite phase (high-temperature rigid state). In some implementations, a wire carrying current is disposed close to the SMA material to heat the SMA material for actuation purposes. In implementations of the disclosure where thermally actuated SMA actuators are used, the processing logic (e.g. processing logic 107) is configured to thermally control the actuation speed of the SMA actuators. In some implementations, the processing logic thermally controls the actuation speed of the SMA actuator by adjusting an ambient temperature proximate to the SMA actuator.

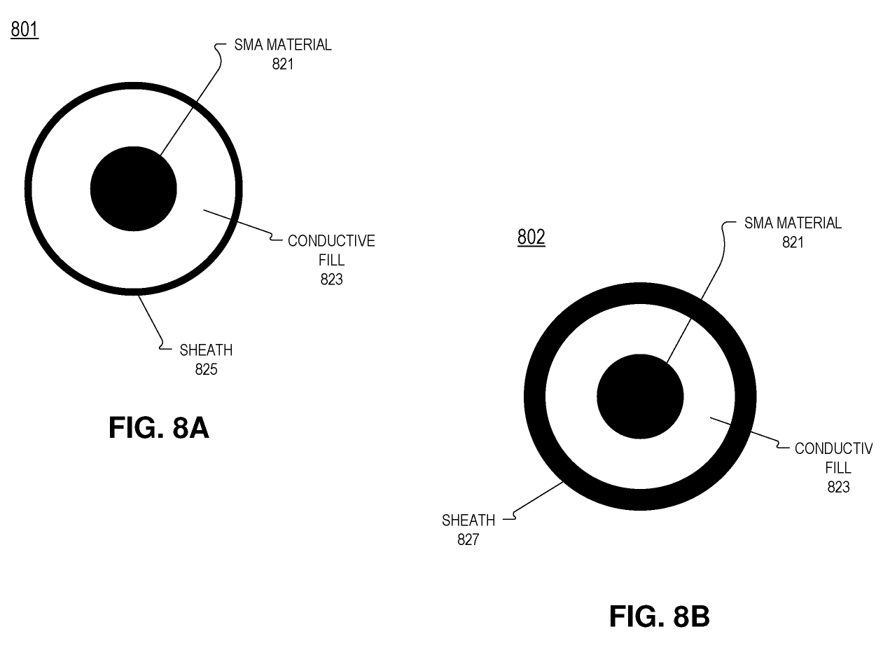

FIG. 8A illustrates a cross-section of an example SMA actuator 801, in accordance with aspects of the disclosure. The cross-section of SMA actuator 801 may be extruded to form an SMA wire. SMA actuator 801 includes an SMA material 821 that is surrounded by a conductive fill material 823. Conductive fill material 823 may include a wire mesh to carry an electrical current that heats SMA material 821 to actuate SMA material from a contracted state to an expanded second state. Conductive fill material 823 may be enclosed by a sheath layer 825. Sheath 825 may be an electrical insulation layer. Sheath 825 may be a thermal insulation layer.

In an implementations of the disclosure, an SMA actuator includes a sheath disposed around an SMA wire where the sheath has a high thermal conductivity that impedes the SMA actuator from reaching a critical temperature for actuation. Conventional SMA actuators would not add a high thermal conductivity sheath to an SMA actuator because it would delay the actuation of the SMA actuator. However, to reduce the speed of actuation, a high thermal conductivity sheath (e.g. sheath 825) will act as a heat sink so that the SMA material 821 gets to the critical temperature at a delayed time. In an implementation, the SMA actuator includes a sheath disposed around an SMA wire and the sheath has a high thermal resistivity that insulates the SMA wire to retain heat to prevent or delay the SMA actuator from dropping below a critical temperature for actuation to effect a subsequent actuation cycle of the SMA actuator.

In an implementation of the disclosure, an SMA actuator includes a sheath disposed around an SMA wire where the sheath mechanically restricts a contraction of the SMA actuator. FIG. 8B illustrates an example SMA actuator 802 having a sheath 827 that mechanically restricts contraction of the SMA actuator 802, in accordance with aspects of the disclosure. Sheath 827 may be thicker than the thickness of a conventional sheath, for example, in order to restrict contraction. Mechanically restricting the SMA actuator 802 may function as a damper that reduces the actuation speed of the SMA actuator.

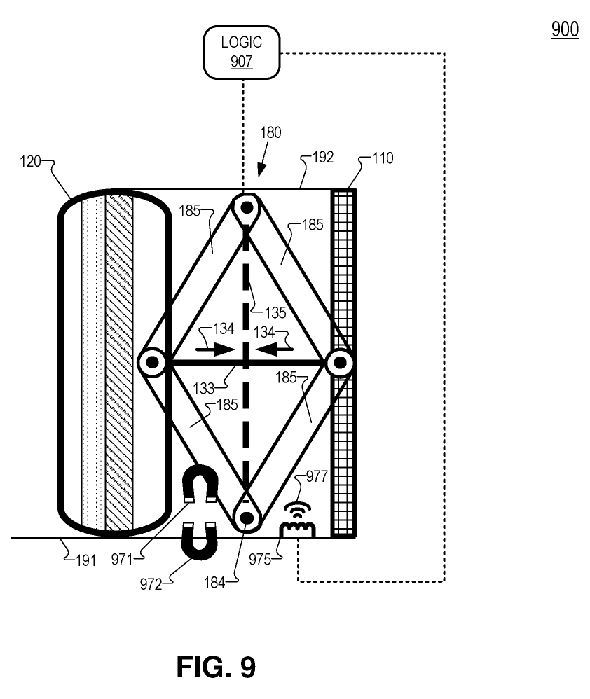

FIG. 9 illustrates an SMA actuator system 900 that includes magnetic elements, in accordance with aspects of the disclosure. SMA actuator system 900 is similar to SMA actuator system 100 that includes a display 110, an optics block 120, an actuation block 180, and processing logic 907. SMA actuator system 900 is illustrated in a contracted state to facilitate a short focal plane. SMA actuator system 900 may be configured to control the actuation speed of one or more SMAs included in system 900 with the assistance of magnetic fields.

Processing logic 907 is configured to control SMA actuators 133 and 135 in addition to being coupled to control a magnetic field generator 975. Processing logic 907 may be configured to control the magnetic field 977 generated by magnetic field generator 975 in order to modulate the response of actuation block 180. Magnetic field generator 975 may be an inductor and processing logic 907 may drive an electrical current through the inductor to generate magnetic field 977. Magnetic field 977 may act on an SMA actuator (e.g. 133 or 135) or act on a part in the linkage (e.g. linkage 185) to reduce the speed of the SMA actuator. Magnetic field 977 may attract a ferrous material in either linkage 185 or SMA actuator 133 or 135 to reduce the speed of the movement of actuation block 180. By way of example, attracting pivot point 184 toward magnetic field generator 975 will counter (and slow) the pulling force 134 provided by the contraction of SMA actuator 133. Magnetic field generator 975 may be placed closer to pivot point 184 in some implementations. Magnetic field generator 975 may be disposed on a frame of a device. In some implementations, the chemistry of the SMA actuator is ferrous and attracting the SMA actuator toward magnetic field generator 975 will counter (and slow) the pulling force 134 provided by the contraction of SMA actuator 133.

In some implementations, a fixed magnet 971 is added to actuation block 180 (e.g. to one of the linkage 185) to interact with magnetic field 977. Depending on the orientation of the fixed magnetic 971, the fixed magnetic 971 may be attracted to or repelled by magnetic field 977 to slow the speed of SMA actuators in actuation block 180. In some implementations, a fixed magnetic 972 is attached to a frame of the device to interact with fixed magnet 971. Depending on the orientation of the fixed magnetic 972, fixed magnetic 972 may be attracted to or repelled by fixed magnetic 971 to slow the speed of SMA actuators in actuation block 180.

In the SMA actuator system 900, more than one magnetic field generator 975, fixed magnetic 971, and/or fixed magnetic 972 may be utilized to reduce the speed of SMA actuators in actuation block 180.

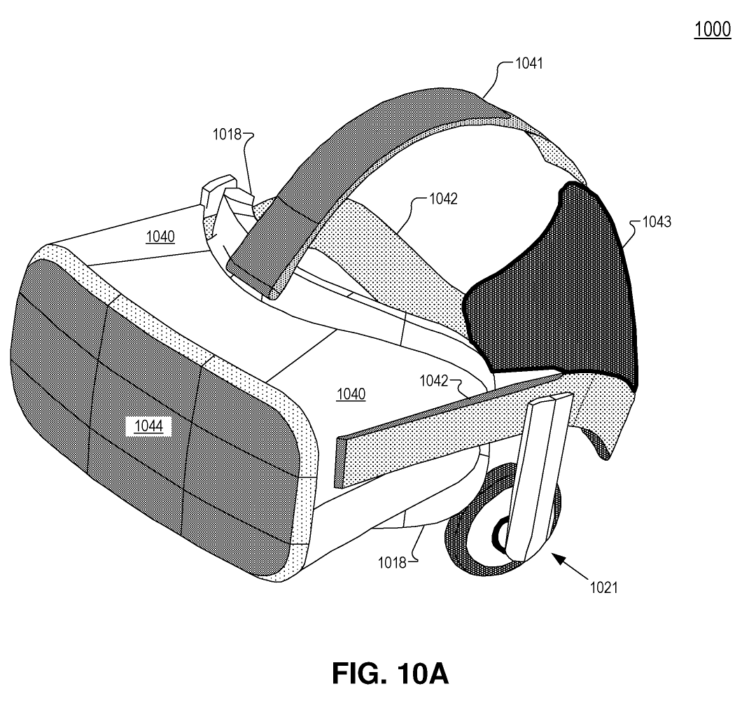

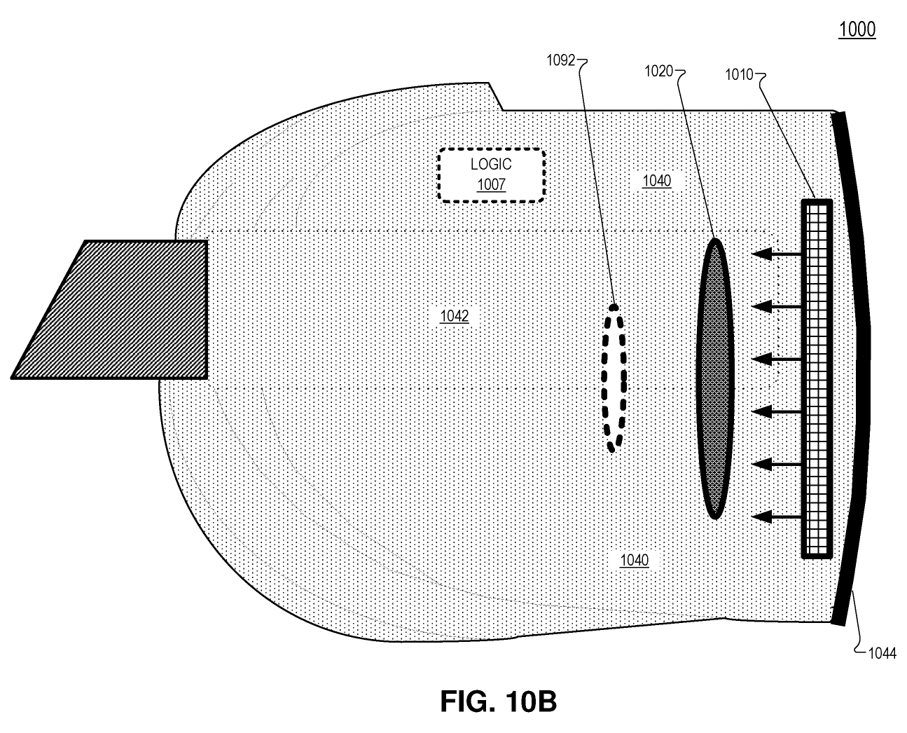

FIG. 10A illustrates an example head mounted display (HMD) 1000 that may include an SMA actuator system, in accordance with aspects of the disclosure. HMD 1000 includes a top structure 1041, a rear securing structure 1043, and a side structure 1042 attached with a viewing structure 1040, in accordance with implementations of the disclosure. The illustrated HMD 1000 is configured to be worn on a head of a user of the HMD. In one implementation, top structure 1041 includes a fabric strap that may include elastic. Side structure 1042 and rear securing structure 1043 may include a fabric as well as rigid structures (e.g. plastics) for securing the HMD to the head of the user. HMD 1000 may optionally include earpiece(s) 1021 configured to deliver audio to the ear(s) of a wearer of HMD 1000.

In the illustrated embodiment, viewing structure 1040 includes an interface membrane 1018 for contacting a face of a wearer of HMD 1000. Interface membrane 1018 may function to block out some or all ambient light from reaching the eyes of the wearer of HMD 1000. Viewing structure may include a display side 1044 that is proximate to a display panel that generates virtual images for presenting to an eye of a user of HMD 1000. The display 110 described in the disclosure may be an example of the display panel (or display panels) included in HMD 1000.

Example HMD 1000 also includes a chassis for supporting hardware of the viewing structure 1040 of HMD 1000. Hardware of viewing structure 1040 may include any of processing logic, wired and/or wireless data interface for sending and receiving data, graphic processors, and one or more memories for storing data and computer-executable instructions. In one implementation, viewing structure 1040 may be configured to receive wired power. In one implementation, viewing structure 1040 is configured to be powered by one or more batteries. In one implementation, viewing structure 1040 may be configured to receive wired data including video data. In one implementation, viewing structure 1040 is configured to receive wireless data including video data.

Viewing structure 1040 may include an SMA actuator system described in the disclosure. FIG. 10B illustrates a side view of viewing structure 1040 that includes an example display 1010 generating display light that is focused to eyebox region 1092 by optical system 1020, in accordance with aspects of the disclosure. The disclosed SMA actuator system may be utilized to move optical system 1020 with respect to display 1010 or the SMA actuator system may be utilized to move display 1010 with respect to optical system 1020. The features of processing logic 107 may be implemented in processing logic 1007. The implementations of this disclosure may also be implemented in augmented reality (AR) HMDs and Mixed Reality (MR) HMDs, in addition to the illustrated virtual reality (VR) HMD of FIGS. 10A-B.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g. processing logic 107) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Networks may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A lens assembly comprising:
a display configured to generate display light including an image;
a lens configured to focus the display light;
an actuation block configured to adjust a spacing between the lens and the display, wherein the actuation block comprises a shape memory alloy (SMA) actuator; and
processing logic configured to operate the SMA actuator to control an actuation speed of the SMA actuator.

2. The lens assembly of claim 1, wherein the processing logic is configured to control the actuation speed of the SMA actuator by modulating a current signal directed into the SMA actuator.

3. The lens assembly of claim 2, wherein modulating the current signal includes driving the SMA actuator at a continuous current value that is below a critical current value for actuation of the SMA actuator, and wherein modulating the current signal includes driving the SMA actuator at a continuous current value that is above the critical current value.

4. The lens assembly of claim 2, wherein modulating the current signal comprises pulse width modulation.

5. The lens assembly of claim 4, wherein an amplitude of at least a portion of pulses generated by the pulse width modulation are below a critical current value for actuation of the SMA actuator.

6. The lens assembly of claim 1, wherein the processing logic is configured to control the actuation speed of the SMA actuator by increasing an amplitude of a current signal directed into the SMA actuator in a plurality of steps.

7. The lens assembly of claim 6, wherein the processing logic is configured to control the actuation speed of the SMA actuator by increasing the amplitude of the current signal in a plurality of steps with a delay time between each of the plurality of steps.

8. The lens assembly of claim 1, further comprising an attenuator circuit coupled to the processing logic and to the SMA actuator, and wherein the processing logic is configured to control the actuation speed of the SMA actuator by directing a signal to the SMA actuator via the attenuator circuit.

9. The lens assembly of claim 1, further comprising a low pass filter coupled to the processing logic and to the SMA actuator, and wherein the processing logic is configured to control the actuation speed of the SMA actuator by directing a signal to the SMA actuator via the low pass filter.

10. The lens assembly of claim 1, wherein the processing logic is configured to thermally control the actuation speed of the SMA actuator.

11. The lens assembly of claim 10, wherein the processing logic thermally controls the actuation speed of the SMA actuator by adjusting an ambient temperature proximate to the SMA actuator.

12. The lens assembly of claim 1, wherein the SMA actuator comprises a plurality of SMA wires with different physical properties, and wherein the processing logic is configured to control the actuation speed of the SMA actuator by actuating a subset of the plurality of SMA wires.

13. The lens assembly of claim 12, wherein the different physical properties of the plurality of SMA wires include different dimensions or different material composition.

14. The lens assembly of claim 1, wherein the SMA actuator comprises a plurality of SMA wires having similar physical properties, and wherein the processing logic is configured to control the actuation speed of the SMA actuator by actuating a subset of the plurality of SMA wires.

15. The lens assembly of claim 1, wherein the SMA actuator includes a sheath disposed around an SMA wire, wherein the sheath mechanically restricts a contraction of the SMA actuator.

16. The lens assembly of claim 1, wherein the SMA actuator includes a sheath disposed around an SMA wire, wherein the sheath has a high thermal conductivity that impedes the SMA actuator from reaching a critical temperature for actuation.

17. The lens assembly of claim 1, wherein the SMA actuator includes a sheath disposed around an SMA wire, wherein the sheath has a high thermal resistivity that insulates the SMA wire to retain heat to prevent or delay the SMA actuator from dropping below a critical temperature for actuation to effect a subsequent actuation cycle of the SMA actuator.

18. The lens assembly of claim 1 further comprising:
a magnetic field generator, wherein the magnetic field generator generates a magnetic field that acts on the SMA actuator to control the actuation speed of the SMA actuator.

19. The lens assembly of claim 18, wherein the magnetic field generator includes an inductor configured to generate the magnetic field in response to the processing logic driving a magnetic signal onto the magnetic field generator while the processing logic is driving a control signal to the SMA actuator to control the actuation speed of the SMA actuator.

20. The lens assembly of claim 1 further comprising:
a damping element configured to reduce the actuation speed of the SMA actuator, wherein the damping element includes a friction brake.

21. The lens assembly of claim 1. wherein the SMA actuator is coupled to the display or the lens via a connection point that can be operated to change the angle of actuation of the actuation block to change the resultant speed of actuation of the actuation block.

22. A shape memory alloy (SMA) actuator system comprising:
a payload;
an SMA actuator coupled to the payload; and
processing logic configured to operate the SMA actuator to reduce an actuation speed of the SMA actuator.
